(19) United States
(12) Patent Application Publication
(10) Pub. No.: US 2006/0200854 A1
(43) Pub. Date: Sep. 7, 2006

(54) Server with authentication function, and authentication method

(76) Inventor: Shinichi Saito, Ashigarakami-gun (JP)

Correspondence Address: GAUTHIER & CONNORS, LLP, 225 FRANKLIN STREET, BOSTON, MA, 02110, US

(21) Appl. No.: 11/215,342

(22) Filed: Aug. 30, 2005

(30) Foreign Application Priority Data
Mar. 2, 2005 (JP) 2005-057974

(51) Int. Cl. H04L 9/32; H04L 9/00; G06K 9/00; H04K 1/00; G06F 17/30; G06F 7/04

(52) U.S. Cl. 726/2; 713/182; 713/176

(57) ABSTRACT

A server for authenticating a user has a receiving unit, an identification mail transmitting unit and an authentication control section. The receiving unit receives an authentication request from the user. The identification mail transmitting unit transmits an identification mail to the user. The identification mail identifies whether or not the user is a legitimate user. The authentication control section determines that the authentication request is unsuccessful regardless of whether or not a digital signature on the authentication request is valid, when the identification mail identifies that the user is not the legitimate user.

### BACKGROUND OF THE INVENTION

1. Field of the Invention

The present invention relates to a scheme for user identification in electronic commerce and other communication via a network.

2. Description of the Related Art

In recent years, various measures have been devised and employed to prevent fraudulent actions such as spoofing in electronic commerce.

For example, Japanese Patent Laid-Open Publication No. 2004-013831 describes a technique in which, after a user is authenticated using a password or the like when the user logs into a server, biometric information of the user such as a fingerprint is continually transmitted from the user terminal to the server during the login period, so as to prevent spoofing throughout the login period.

Although this scheme is effective for preventing spoofing because biometric information unique to each user is employed, a system according to this scheme is disadvantageous in that it requires high costs.

According to a system described in Japanese Patent Laid-Open Publication No. 2003-188873, a user terminal acquires from an authentication server a digital certificate having incorporated therein an identifier, such as a MAC (Media Access Control) address, unique to a hardware device within the user terminal. When an attempt is made to perform an electronic commerce session or the like using a digital certificate on the user terminal, the session is permitted only when, upon comparison, the hardware identifier incorporated in the digital certificate matches the hardware identifier obtained from the hardware within the user terminal. Use of fraudulently acquired digital certificates can thereby be prevented according to this system.

However, this system disadvantageously inconveniences users because the terminals which the user can use are restricted.

Digital signatures are widely employed in user identification or authentication systems which use a public key infrastructure (PKI), such as described in the above-noted Japanese Patent Laid-Open Publication No. 2003-188873. User identification based on digital signature is commonly performed by means of a key pair or a digital (or public key) certificate which are stored in a user terminal, or a combination of a private key retained in an IC card carried by a user and a digital certificate. Although conventional user authentication schemes may be effective if operated properly, these schemes are disadvantageous in that, should a third party obtain the file of a key pair or the IC card by theft or the like, fraudulent use is possible, and, in fact, very easy.

### SUMMARY OF THE INVENTION

The present invention provides a scheme which prevents fraudulent use of misappropriated tools such as a key pair or an IC card which include a private key used by a user for authentication.

According to an aspect of the present invention, there is provided a server for authenticating a user. The server has a receiving unit, an identification mail transmitting unit and an authentication control section. The receiving unit receives an authentication request from the user. The identification mail transmitting unit transmits an identification mail to the user. The identification mail identifies whether or not the user is a legitimate user. The authentication control section determines that the authentication request is unsuccessful regardless of whether or not a digital signature on the authentication request is valid, when the identification mail identifies that the user is not the legitimate user.

### BRIEF DESCRIPTION OF THE DRAWINGS

Embodiments of the present invention will be described in detail based on the following figures, wherein:

FIG. 1 is a functional block diagram showing a first embodiment of a system incorporating the present invention;

FIG. 2 shows a flow of user authentication processing performed in the system of the first embodiment;

FIG. 3 is a diagram showing operations performed by the system of the first embodiment when a legitimate user requests authentication;

FIG. 4 is a diagram showing operations performed by the system of the first embodiment when an illegitimate user requests authentication;

FIG. 5 is a diagram showing a system configuration in which the identification mail is to be sent to a user's portable mail terminal; and

FIG. 6 is a diagram showing a flow of user authentication processing according to an additional embodiment of the present invention.

### DESCRIPTION OF THE EMBODIMENTS

Embodiments of the present invention will next be described referring to the drawings.

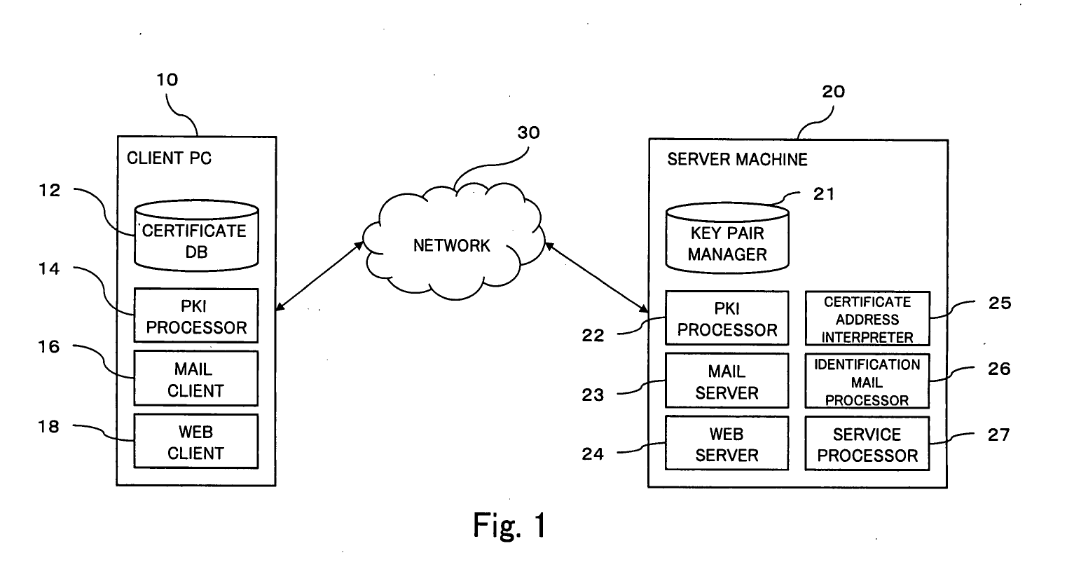

FIG. 1 is a functional block diagram showing an embodiment of a system incorporating the present invention.

A client PC 10 is a computer device operated by a user. The client PC 10 has a certificate DB (database) 12 in which the user's public key certificate (hereinafter simply referred to as “certificate”) and a corresponding private key are registered. A PKI processor 14 is a functional module which executes processing with regard to security within the PKI (public key infrastructure). While this processing may include performing the processes of attaching a digital signature to data, verifying a digital signature attached to data, encoding data, and decoding data, the PKI processor 14 may not necessarily perform all of these processes. The PKI processor 14 may comprise, without limitation, protocols of SSL (Security Socket Layer) and S/MIME (Secure Multipurpose Internet Mail Extension). An application in the client PC 10 can make use of the PKI processor 14 in order to deal with threats of spoofing, tapping, and the like during a communication with an apparatus (such as a server machine 20) via a network 30 such as the Internet. As examples of applications used in the client PC 10, FIG. 1 shows a mail client 16 for transmitting and receiving e-mails, and a web client (such as web browser) 18 which performs processing using HTTP (HyperText Transfer Protocol). These examples are not limited, and other applications may be used.

The server machine 20 is a computer device which provides a service to the client PC 10 via the network 30. One example of a services provided by the server machine 20 is web pages and web applications by a web server 24 shown in FIG. 1. Other examples include a file transfer service according to FTP (File Transfer Protocol) and many other services. One characteristic feature of the server machine 20 according to the present embodiment relates to the function and content of processing for the purpose of user (client) authentication (described in detail later), and this feature basically does not depend on the types of services provided by the server machine 20 to the client PC 10.

A key pair manager 21 in the server machine 20 has stored therein a pair of public key and private key of the server machine 20 itself. Instead of the public key, a public key certificate including the public key may be stored. Similarly as the PKI processor 14 of the client PC 10, a PKI processor 22 of the server machine 20 executes processing within the PKI.

The web server 24 is a server which provides web page data to the client PC 10. The web server 24 may receive an instruction from a user by employing a web page as a user interface (UI), and provide a service corresponding to the instruction using CGI (Common Gateway Interface) technique. The actual processing of the service is executed by a service processor 27. Because the content of the service provided by the service processor 27 to a user is basically unrelated to the essence of the present invention, its explanation is omitted.

A mail server 23 is used to transmit an identification mail (described in detail below) to a user.

A certificate address interpreter 25 reads, from a certificate which was received from the client PC 10, an e-mail address of a user who is the subject of the certificate.

An identification mail processor 26 transmits to a user's mail address, in response to a user authentication request from the user, an identification mail for confirming whether the request was actually originated by that user. The identification mail processor 26 further executes user identification processing triggered by the mail transmission. A specific example of the user identification processing is described later.

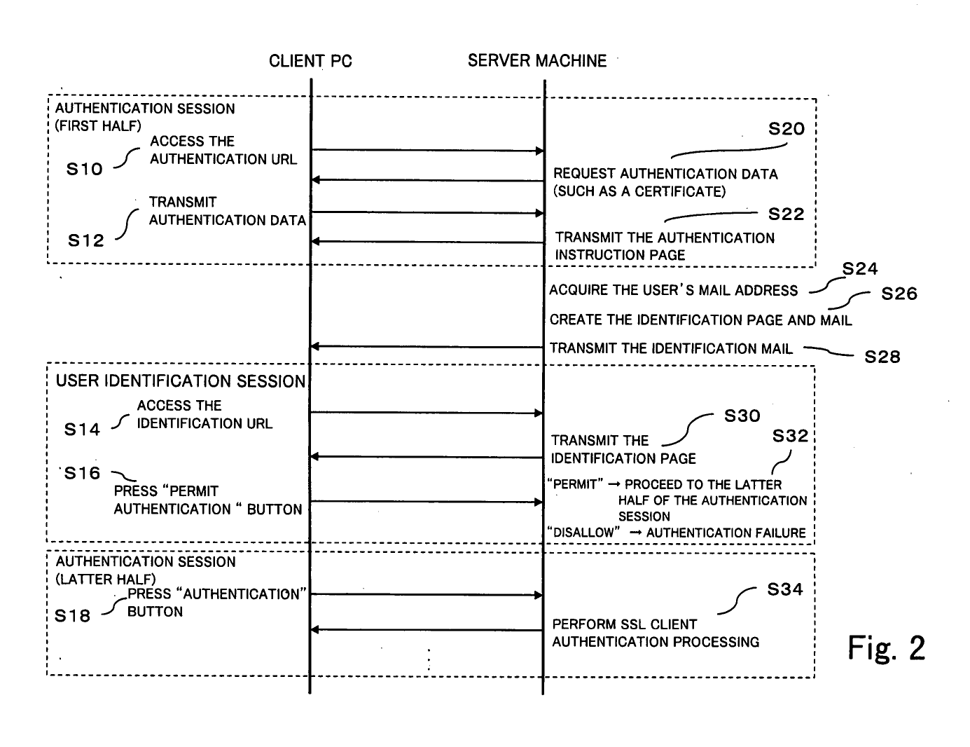

FIG. 2 shows a flow of user authentication processing. The following description is made referring to client authentication using SSL as an example.

First, the web client 18 of the client machine 10 accesses the URL of a web page which is located in the web server 24 of the server machine 20 and which requires client authentication (S10). This access is performed using HTTPS (HyperText Transfer Protocol Security).

The accessed web server 24 sends a request for authentication data to the web client 18 using the protocol of the PKI processor 22 (S20). In this manner, processing related to authentication required by the web server 24 is actually executed by the PKI processor 22. However, to facilitate explanation, this processing may be hereinafter simply described as “being executed by the web server 24”. This also applies to descriptions of the web client 18.

The authentication data requested in S20 include a certificate of the user and the user's digital signature with respect to a message (hello message) sent to the web client 18 when making the request in S20. In order to deal with a case in which multiple certificates of the user are registered in the certificate DB 12, it may be preferable to display a list of certificates on a screen so as to persuade the user to select one certificate from the list. In this case, a web page which serves as the UI for making the selection is supplied in S20. If an IC card of the user is to be used, the IC card is read by a card reader provided at the client PC 10. A certificate of the user retained within the IC card is copied into the certificate DB 12, and then displayed within the list of certificates.

Upon receiving a request for authentication data, the web client 18 requests the PKI processor 14 to attach a digital signature using the user's private key to the hello message received in S20. Subsequently, the web client 18 transmits back to the web server 24, as the authentication data, a pair of a message signed and returned by the PKI processor 14 according to the web client's request and a certificate of the user acquired from the certificate DB 18 (S12).

If the web page for selecting a certificate is provided by the web server 24, the web client 18 displays this web page on a screen of the client PC 10 in S12. This web page shows a list of certificates stored in the certificate DB 12, and has incorporated therein input means according to JavaScript (trademark), for example, for receiving input of the user's selection. Via this input means, the user selects a certificate to be used. The PKI processor 14 then signs the above-noted hello message using a private key corresponding to the selected certificate. The web client 18 transmits the signed message and the selected certificate as the authentication data to the web server 24 (S12).

In a conventional SSL authentication session, the web server 24 next performs user authentication by verifying the digital signature attached to the message included in the authentication data using the public key within the public key certificate which is also included in the authentication data. In contrast, according to the present embodiment, before verifying the signature, an identification mail is sent to the mail address of the user who originated the request for authentication so as to perform user identification. This processing is executed by steps S24-S28. It should be noted that the HTTPS session comprising the above-described steps of S10, S20, and S12 corresponds to the first half of the authentication processing based on digital signature.

The processing of steps S24-S28 is executed by the identification mail processor 26 in response to a request from the PKI processor 22. The details of this processing are described below.

In S24, the certificate address interpreter 25 acquires the user's mail address from the certificate received from the web client 18. Typically, the user's (subject's) mail address is recited in the certificate in the subject field or in the subject alias name field in the extended profile of RFC3280 (the new version of RFC2459). This mail address is read out in S24.

In S26, an identification mail to be sent to the read-out mail address and a web page used for user identification (referred to as “identification page”) are created.

It should be noted that the address (URL) of the identification page is a temporary address which is dynamically generated each time an authentication request is received from a user (in S10). A temporary address is used in order to make it difficult for those who attempt fraud to know or guess the URL of the identification page. For example, the URL of the identification page may be set by randomly selecting from among a predetermined range within the domain managed by the web server 24. The content of the identification page can be in any form as long as the user who receives the identification mail can make an input for confirming that the authentication request of S10 was in fact transmitted by the user. For example, the identification page may display a message such as “An authentication request was made. Do you permit this request?”, along with GUI (graphical user interface) controls for granting permission or denying the request.

The URL of the identification page is recited within the text or the like of the created identification mail which is addressed to the mail address acquired in S24. The identification mail may include a message such as “Access the URL below to perform user identification”. When this mail is received by the user, the user can accesses the identification page by, for example, clicking the URL of the identification page shown on a display screen when this mail is displayed by the mail client 16. The user can then express the intent to permit or disallow the authentication request. It should be noted that the order in which the step of creating the identification page and the step of acquiring the mail address are performed is not limited to that described above.

When the identification page and the identification mail are created, the identification mail is handed over to the mail server 23 and sent out (S28).

When performing the above-described identification mail processing (S24-S28), the web server 24 transmits to the web client 18 of the client PC 10 an authentication instruction web page including a message explaining that the identification processing by means of an identification mail is performed, and a GUI button for instructing start of the authentication processing using digital signature (referred to as “authentication button”) (S22). The message shown in this page may be, for example, “A mail for user identification is being sent to you. After receiving the mail and performing the identification processing, press the ‘authentication button’”. With this message, it is possible to notify the current progress of the authentication processing to the user of the web client 18, while also persuading the user to perform the identification processing with respect to the identification mail.

When the user receives the identification mail, the user sees the identification mail displayed by the mail client 16, and accesses the URL indicated in the mail (S14). In response, the web server 24 within the server machine 20 transmits the identification page corresponding to the URL to the web client 18 (S30). In turn, the web client 18 displays the identification page on the screen. If the user judges that the authentication request referred to in the message shown in the identification page was originated by the user him/herself, the user presses the “permit authentication” button shown in the identification page. On the other hand, if the authentication request was not originate by the receiver of the identification mail, the receiver presses the “disallow authentication” button. When the “permit authentication” button or the “disallow authentication” button is pressed, the web client 18 transmits information indicating the pressed button to the web server 24 (S16). It should be noted that security can be enhanced by performing the above-described user identification session including S14, S30, S16, and S32 as an HTTPS session.

When the web server 24 receives a user input with respect to the identification page, if the input is “disallow authentication”, the web server 24 judges that user authentication concerning the current authentication request is unsuccessful, that is, that the person who requested authentication is not a legitimate user (S32). The web server 24 then transmits back to the web client 18 a web page including a message indicating failure of authentication, and ends the processing performed in response to the authentication request. On the other hand, if the user input with respect to the identification page is “permit authentication”, the processing continues to the latter half of the authentication processing shown in FIG. 2 (S32). When “permit authentication” is input, a web page showing a message such as “Click the ‘authentication button’ in the authentication instruction page” may be provided to the web client 18 so as to persuade the user to continue with the authentication session.

In the latter half of the authentication session, when the user presses the “authentication button” indicated in the authentication instruction page (S18), the content of this operation is transmitted from the web client 18 to the web server 24. In response, the PKI processor 22 resumes the SSL client authentication processing which was interrupted (S34), and verifies the user's digital signature within the authentication data received in S12 using the public key within the user's public key certificate. As a result of the verification, if the digital signature is determined as the user's own, the PKI processor 22 judges that the user authentication process is successful, and conveys this judgment to the web server 24. In this case, because the user authentication process succeeded, the service from the service processor 27 is provided to the user side. On the other hand, if the digital signature is determined as not being the user's own, the user authentication process is judged unsuccessful, and a web page indicating the failure is transmitted to the web client 18.

When the authentication button in the authentication instruction page provided in S22 is pressed before the user sends, in S16, a response to permit authentication in reply to the identification mail, the web server 24 may determine that the user authentication process is unsuccessful or, alternatively, the web server 24 may ignore the early authentication button response and provide to the web client 18 a web page for inviting the user to again perform the operation for user identification based on identification mail.

In the procedure shown in FIG. 2, the authentication instruction page containing the authentication button for instructing continuation of the authentication session processing based on digital signature is transmitted to the user side (S22) prior to the user identification processing triggered by the identification mail. Instead, a similar authentication instruction page containing the authentication button may be transmitted to the user side after identification of the user is confirmed in S32 during the user identification session.

Further, according to the procedure shown in FIG. 2, the web server 24 sends a hello message to the web client 18 in S20, and in turn the user's certificate and the hello message signed by the user are sent back from the web client 18 to the web server 24 in S12. However, the authentication processing flow is not limited to that described above. As an alternative, steps S20 and S12 may only involve requesting of a certificate and submission of the certificate to the server in return. In this case, the hello message is sent from the server in S34 after user identification is confirmed in S32, and the user subsequently signs and sends back the hello message for receiving authentication.

Moreover, while the digital signature submitted from the client PC 10 side is verified by the server machine 20 after the user manually inputs “permit authorization” through the identification page according to the procedure of FIG. 2, this processing flow is not a requirement. Alternatively, for example, a sequence of steps such as the following may be performed. That is, verification of the digital signature is simultaneously performed and completed during execution of the user identification processing using the identification mail and page. Even when the verification is successful, this success is retained in a pending state to avoid immediately determining success of user authentication. Subsequently, when the user inputs “permit authorization” through the identification page, the user authentication result which was held in the pending state is validated to determine success of authentication. According to this sequence, if the verification of digital signature fails, authentication failure is determined without waiting for an input from the identification page. Advantages equivalent to those achieved by the procedure of FIG. 2 can be accomplished by this processing sequence.

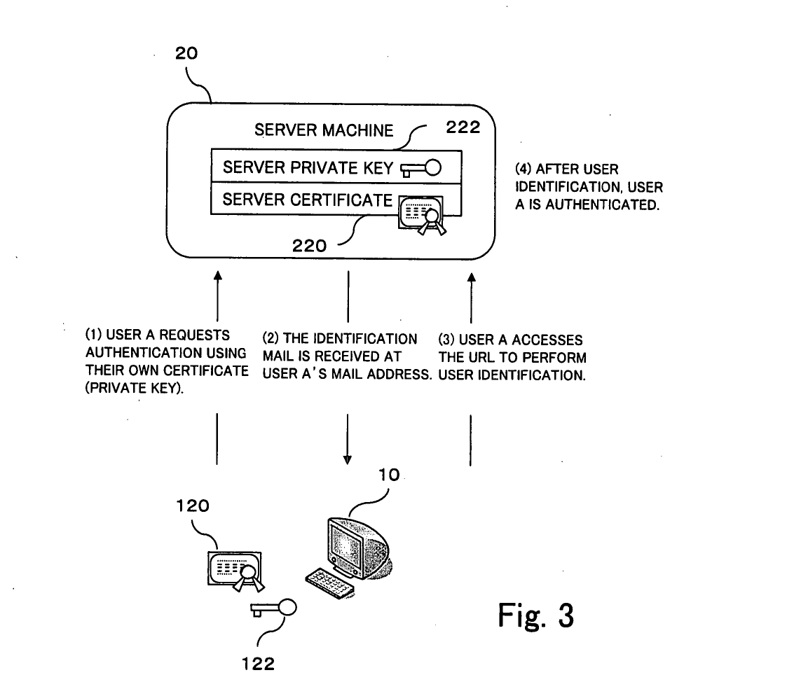

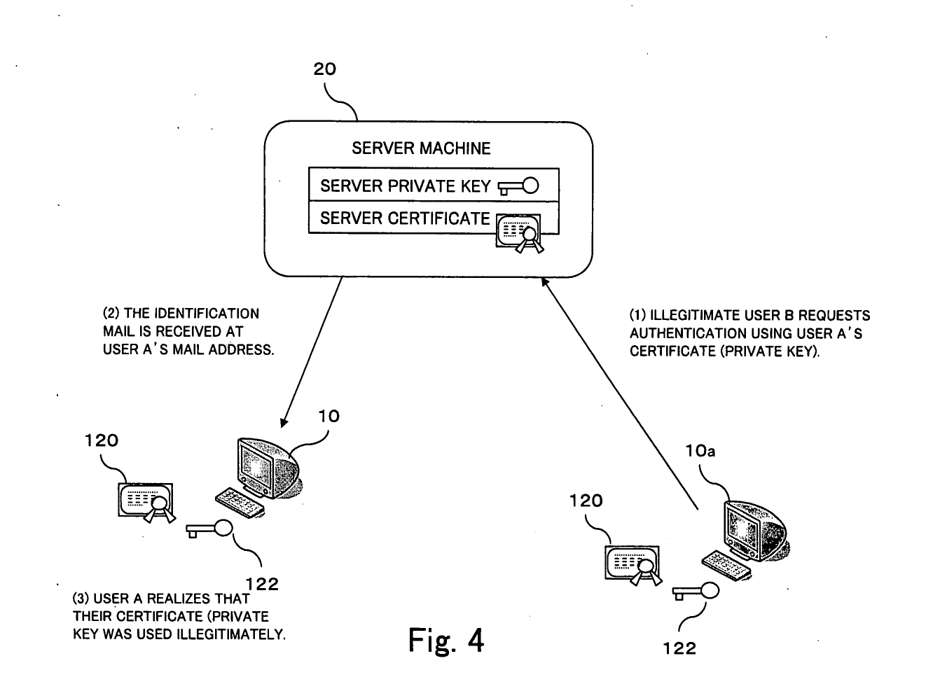

Referring to FIGS. 3 and 4, the advantages achieved by the present embodiment are next described.

A case in which a legitimate user attempts to receive user authorization is first explained referring to FIG. 3.

When (1) legitimate user A sends a request for user authentication using the user's own certificate (and private key) to the server machine 20 from the client PC 10 having installed therein the user's certificate 120 and private key 122, (2) the server machine 20 transmits an identification mail to a mail address indicated in the certificate. In this case, the identification mail is sent to the mail address owned by the legitimate user A. Accordingly, user A sees the mail displayed by the mail client 16, and (3) accesses the URL of the identification page indicated in the mail so as to perform user identification. After this user identification process, (4) the server machine 20 performs user authentication using the certificate and the digital signature. Here, the user authentication process succeeds because user A is legitimately using their own certificate and private key.

It should be noted that the server machine 20 possesses its own certificate 220 and private key 222 which may be employed according to necessity during communication with the client PC 10.

Next, a case in which user B who somehow obtained user A's certificate 120 and private key 122 uses those items to spoof being user A is described referring to FIG. 4.

In this case, when (1) illegitimate user B requests user authentication by submitting user A's certificate from user B's PC 10a to the server machine 20, (2) the server machine 20 transmits an identification mail to user A's mail address indicated in the certificate. Accordingly, (3) legitimate user A is able to realize that their certificate is being used illegitimately. Furthermore, user A can block illegitimate user B from receiving user authentication by accessing the identification page from the received identification mail and pressing the “disallow” button. Because the server machine 20 does not determine success of the certificate-based user authentication process unless the user inputs “permit authentication” through the identification page, erroneous authentication of user B as user A is avoided even if legitimate user A fails to notice the arrival of the identification mail, or if user A notices the mail but does not press the “disallow” button on the identification page.

Although in the above-described examples, the user identification process is performed by having the user access the identification page denoted in the identification mail, the system may alternatively be configured such that the intent to “permit authorization” can be expressed by a return mail transmitted in reply to the identification mail. More specifically, when the user receives the identification mail and wishes to permit the authorization process, the user sends a return mail with respect to the identification mail via the mail client 16. When the server machine 20 receives the return mail in reply to the identification mail, the server machine 20 judges that the authentication process is permitted, and performs the authorization process based on digital signature. According to this scheme, user identification can be performed even when the client operated by the user does not include a web browser.

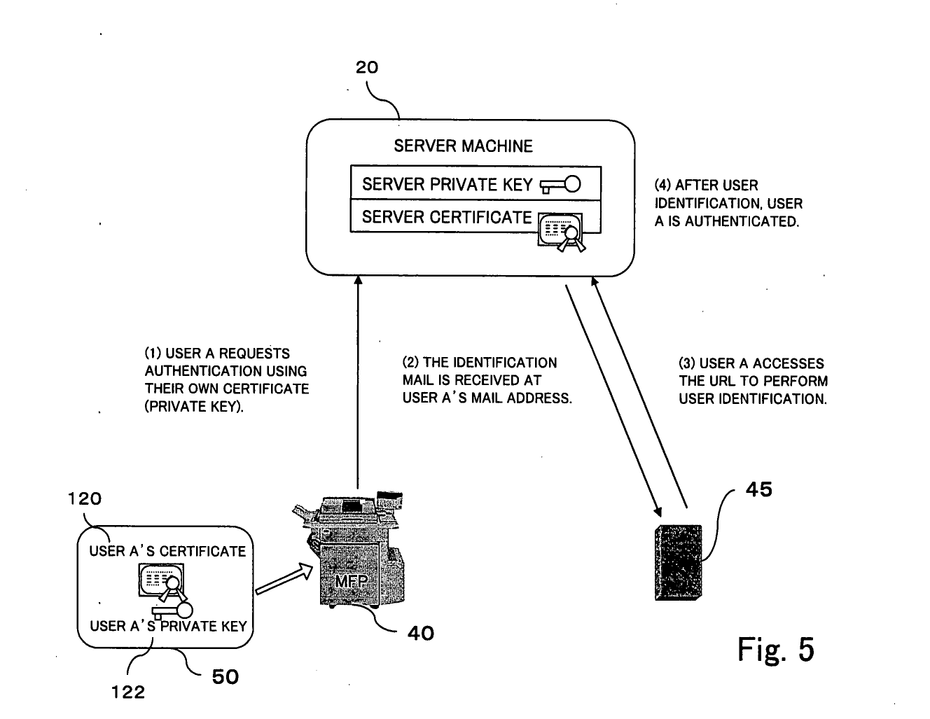

While the client application which requests certificate-based user authentication (web client 18 in the example of FIG. 1) and the mail client 16 which receives the identification mail are provided in the same client PC 10 in the above-described embodiments, such configuration is not a requirement of the present invention. In the example shown in FIG. 5, the client machine which requests certificate-based user authentication is a digital multifunction center 40, while a portable mail terminal (such as a cellular phone) 45 is employed as the mail client which receives the identification mail. A digital multifunction center 40 is an apparatus which incorporates the functions of a printer, scanner, and copier, and is connected to the server machine 20 via a network such as a LAN or the Internet. Using this system, user A can receive services from the server machine 20 through the multifunction center 40. One example of such services is registering of document data scanned by the multifunction center 40 into a server machine 20 which functions as a document server. It is expected that use of various servers on a network from a multifunction center 40 will be increasing more and more in the near future. According to the system of FIG. 5, user A sets on a card reader of the multifunction center 40 an IC card 50 having therein the user's own certificate 120 and private key 122. User A then inputs via a UI screen of the multifunction center 40 an instruction expressing the intent to use a service offered by the server machine 20. At this point, (1) the PKI processing protocol installed in the multifunction center 40 accesses the server machine 20 using user A's certificate which was read out from the IC card 50, so as to request user authentication. Subsequently, (2) the server machine 20 acquires user A's mail address from the certificate, and sends an identification mail to the acquired address. User A receives the identification mail at their portable mail terminal 45, and (3) accesses the identification page from the URL indicated in the mail so as to execute user identification. After that, (4) the server machine 20 performs user authentication based on the certificate and the digital signature. In this example, because legitimate user A is correctly using their own certificate and private key, user authentication succeeds. It should be noted that step (3) for user identification need not be performed using an identification page. Alternatively, it may be possible to automatically determine that user identification is confirmed when the server machine 20 receives a return mail in reply to the identification mail from the user.

While user identification is performed by accessing the server machine 20 from user A's portable mail terminal 45 in the example of FIG. 5, the user identification process may alternatively be performed by, for example, transferring information of the identification mail from the portable mail terminal 45 to the multifunction center 40 and accessing the server machine 20 from the multifunction center 40. More specifically, a code image for user identification having a format according to a predetermined code scheme, such as a QR code (trademark) or a barcode, may be incorporated in the identification mail. This identification code image may show a predetermined code for expressing user confirmation of identification (this code need be known only to the server machine 20). The identification mail may include the identification code image and a message for guiding user operation such as “An authentication request was made. If you permit this request, display the attached code image on the screen, place the screen facing downward at the position of the arrow on the document scanner of the multifunction center, then press the start button”. When the user receives this identification mail, according to the message, the user displays the identification code image on the display screen of the portable mail terminal 45, and places this display screen at the specified position over the platen of the multifunction center 40. At the point when this operation is carried out, the multifunction center 40 is in a standby state ready to perform a processing with respect to the user authentication request made in previous step (1) (refer to FIG. 5). Accordingly, when the start button is pressed, the multifunction center 40 judges the pressing of the start button as an instruction for reading an identification code image, and, after scanning, recognizes the code image from a predetermined position within the scanned image. The multifunction center 40 then interprets the content of the code, and transmits the code to the server machine 20. Upon receipt of the code, the server machine 20 judges that the user performed the user identification process. According to this scheme, the user's operation of allowing the multifunction center 40 to read the code information included in the identification mail serves as the basis for determining success of user identification.

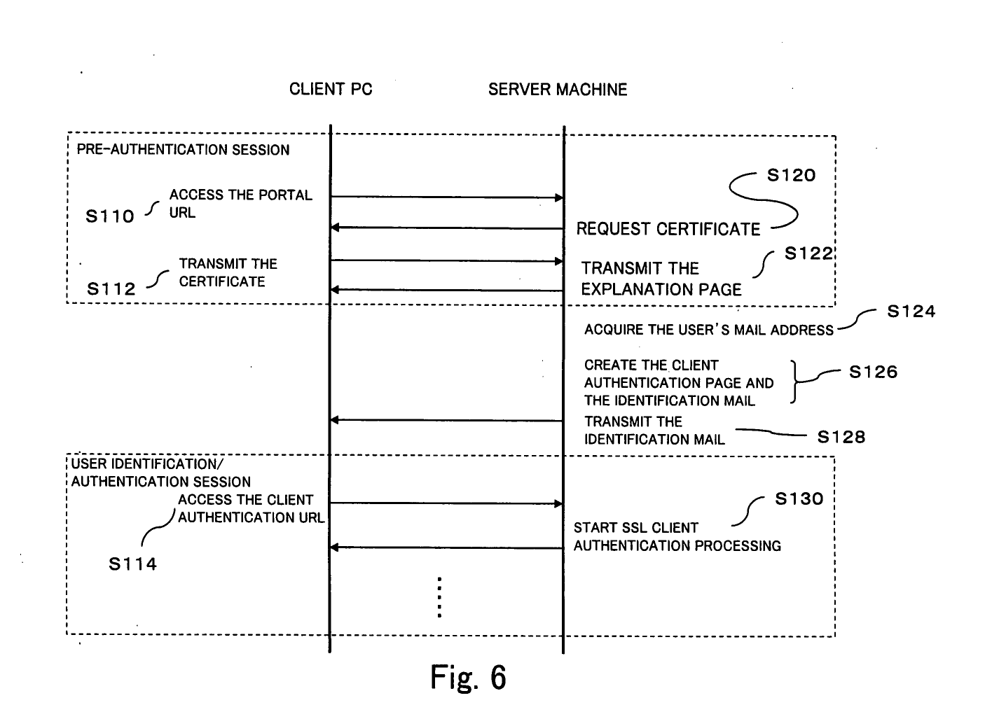

According to the procedure shown in FIG. 2, the SSL authentication session is interrupted midway, and resumed when identification is confirmed as a result of the user identification session (S14, S30, S16, S32). However, this sequence of steps is described by way of example only. Alternatively, the sequence of steps as shown in FIG. 6 may be employed.

In the procedure of FIG. 6, in accordance with the user's operation, the client PC 10 accesses the URL of the web authentication portal page in the server machine 20 by HTTPS (S110). In turn, the server machine 20 supplies to the client PC 10 a UI web page for receiving input of the user's certificate (S120). When the user selects and inputs a certificate to be used via the UI web page, the certificate is transmitted to the server machine 20 (S112). Upon receipt of the certificate, the server machine 20 provides to the client PC 10 an explanation web page showing a message for guiding user operation, such as “A mail for authentication is being sent to you. Please retrieve the mail to perform the authentication process and continue with subsequent processes” (S122). At the same time, the server machine 20 executes the identification mail transmission processing (S124-S128).

During the identification mail transmission processing, the server machine 20 acquires the user's mail address from within the user's certificate received from the client PC 10 (S124), and creates a web page for performing SSL client authentication for this specific user (S126). The URL of this SSL client authentication web page uses HTTPS as the protocol, and is dynamically generated (similarly as the URL of the above-described identification page) in response to the user's access to the above-noted portal URL, so as to minimize risks of fraud. The server machine 20 then creates an identification mail including the URL of the client authentication page (S126), and sends this mail to the user's mail address (S128). Other than the URL, the identification mail may also include a message for guiding user operation, such as “Your authentication request is received. If you wish to receive authentication and continue with the processing, access the URL below”.

When the user receives this identification mail and recognizes that the identification mail is in reply to their own authentication request, the user accesses the URL shown in the mail from the client PC 10 (or from a separate terminal with which the user received the identification mail) (S114). In turn, the server machine 20 executes the conventionally known SSL client authentication processing (S130). During this authentication processing, the server machine 20 requests the user to submit a certificate, in return receives the certificate and data including a digital signature made using a private key corresponding to the certificate, and then verifies the signature. When the SSL client authentication processing of S130 is successful, an authenticated session is established between the client PC 10 (web client 18) and the server machine 20 (web server 24). Subsequently, the service processor 27 provides services to the user under the authenticated session.

As such, in the procedure of FIG. 6, the user's access to the client authentication URL included in the identification mail serves as the basis for determining success of user identification. According to this procedure, when a third party attempts to spoof the user's identity, the user is able to realize that an illegitimate access is being attempted because the user receives the identification mail. Further, because the illegitimate third party is not informed of the URL of the actual SSL client authentication page required for receiving services from the server machine 20, illegitimate uses can be effectively prevented.

In the above-described embodiments, the server machine 20 employs, as the mail address of the user requesting authentication, a mail address acquired from within the certificate submitted by the user. However, there may be cases in which the user wishes to have the identification mail sent to an address other than indicated on the certificate. In order to satisfy the wishes of such users, the following modified embodiment may be employed. In this embodiment, the server machine 20 has registered therein a correlation table including, for each user, a mail address indicated in a certificate and a corresponding mail address to be used as the destination for sending an identification mail. When the server machine 20 acquires the subject's mail address from within a certificate received from a user, and finds that a destination mail address for sending an identification mail is registered corresponding to the acquired mail address, the server machine 20 transmits an identification mail to the destination mail address.

Furthermore, while the user is asked to submit a certificate and this certificate is used to acquire a mail address for sending an identification mail in the above-described embodiments, this configuration is not a requirement of the present invention. An alternative system may be configured as below. The server machine 20 has registered therein in advance, for each user, the user's mail address and the user's authentication information such as a password or biometric information. Instead of submitting their own certificate to the server machine 20, the user accesses the server machine 20 and receives authentication using the registered authentication information such as the password. When this authentication process succeeds, the server machine 20 sends an identification mail to the user's mail address (which is registered in the server machine 20). Similarly as in the procedure shown in FIG. 6, the URL of an SSL client authentication page may be included in this identification mail. The subsequent steps are identical to those shown in FIG. 6.

While the embodiments of the present invention are described above referring to SSL authentication by way of example, the scheme of the present invention can generally be applied to any user authentication processing which is performed within the PKI framework based on a certificate and a digital signature.

The advantages of the present invention can be summarized as follows. When a third party somehow obtains a user's key pair data or the user's token, such as an IC card having stored therein the user's private key, and attempts to spoof the identity of the user using the obtained data or token, if user authentication is performed based only on digital signature as according to a conventional scheme, the authentication process would be incorrectly determined successful, thereby erroneously judging the access from the third party to be the access from the legitimate user. In contrast, according to the present invention, such fraudulent accesses are minimized because an identification mail is sent to the legitimate user's mail address, and, when the user's confirmation in reply to this mail is not received back, the user authentication process is determined unsuccessful. Furthermore, when a fraudulent access is attempted, the legitimate user is able to recognize the fact that the attempt is being made because the legitimate user receives an identification mail related to an access to an authenticating server of which the user has no prior knowledge.

The server machine 20 in the above embodiments can generally be implemented by allowing a general-purpose computer to execute a program reciting the above-described functions of the server machine 20. This program is typically provided in a recorded state within a storage medium readable by a computer, such as optical disks including CD-ROM and DVD-ROM, magnetic disks including a floppy (trademark) disk or hard drive.

As mentioned above, according to an aspect of the present invention, there is provided a server having an authentication function for performing user authentication by verifying a signature of authentication data which has been digitally signed using a user's private key. When this authenticating server receives from a client machine a request to authenticate a user, the authenticating server sends to an electronic mail address of the user an identification mail which is an electronic mail for user identification. Unless the authenticating server receives a confirmation input from the user in reply to the identification mail, the user authentication process is determined unsuccessful. In other words, regardless of whether or not the digital signature of the authentication data is valid, the user authentication process is determined unsuccessful if the authenticating server does not receive an input confirming that the user has replied to the identification mail.

The entire disclosure of Japanese Patent Application No. 2005-057974 filed on Mar. 2, 2005 including the specification, claims, drawings, and abstract is incorporated herein by reference.

What is claimed is:

1. A server for authenticating a user comprising:
a receiving unit that receives an authentication request from the user;
an identification mail transmitting unit that transmits an identification mail to the user, the identification mail that identifies whether or not the user is a legitimate user; and
an authentication control section that determines that the authentication request is unsuccessful regardless of whether or not a digital signature on the authentication request is valid, when the identification mail identifies that the user is not the legitimate user.

2. The server according to claim 1, wherein the identification mail has an address of a web page used for user identification.

3. The server according to claim 2, wherein
the address of the web page is a temporary address which is dynamically generated each time based on the authentication request from the user.

4. The server according to claim 1, further comprising:
an identification web page creating section that create an identification web page, the identification web page that identifies the user; and
wherein the identification mail transmitting unit transmits the identification mail including an address information of the identification web page created by the identification web page creating section.

5. A method for authenticating a user comprising:
receiving an authentication request from the user;
transmitting an identification mail to the user, the identification mail that identifies whether or not the user is a legitimate user; and
determining that the authentication request is unsuccessful regardless of whether or not a digital signature on the authentication request is valid, when the identification mail identifies that the user is not the legitimate user.

6. The method according to claim 5, wherein the identification mail has an address of a web page used for user identification.

7. The method according to claim 6, wherein
the address of the web page is a temporary address which is dynamically generated each time based on the authentication request from the user.

8. The method according to claim 5, further comprising:
creating an identification web page, the identification web page that identifies the user; and
wherein the identification mail including an address information of the identification web page.

9. A storage medium readable by a computer, the storage medium storing a program of instructions executable by the computer to perform a function for authenticating a user, the function comprising:
receiving an authentication request from the user;
transmitting an identification mail to the user, the identification mail that identifies whether or not the user is a legitimate user; and
determining that the authentication request is unsuccessful regardless of whether or not a digital signature on the authentication request is valid, when the identification mail identifies that the user is not the legitimate user.

10. The storage medium according to claim 9, wherein the identification mail has an address of a web page used for user identification.

11. The storage medium according to claim 10, wherein
the address of the web page is a temporary address which is dynamically generated each time based on the authentication request from the user.

12. The storage medium according to claim 9, further comprising:
creating an identification web page, the identification web page that identifies the user; and
wherein the identification mail including an address information of the identification web page.

13. A server with an authentication function, which receives a User authentication request from a client machine via a network, also receives from the client machine in correlation with the user authentication request authentication data having a digital signature attached thereto using a private key of a users and verifies the digital signature on the authentication data to thereby execute a user authentication process in response to the user authentication request, the server comprising:
an identification mail transmitting section which, when the user authentication request is received from the client machine, transmits to an electronic mail address of the user an identification mail that invites the user to make an input indicating whether or not the user authentication request was in fact originated by the user; and
an authentication control section which, when an input indicating that the user authentication request was originated by the user is not received from the user in reply to the transmitted identification mail, determines that the user authentication process is unsuccessful regardless of whether or not the digital signature on the authentication data is valid.

14. The server as defined in claim 13, wherein
the identification mail transmitting section creates the identification mail including an address information of an identification web page for receiving the input indicating whether or not the user authentication request was originated by the user, and transmits the created identification mail to the electronic mail address of the user; and
the authentication control section judges whether or not the user authentication request was originated by the user based on the user's input with respect to the identification web page.

15. The server as defined in claim 14, further comprising:
an identification web page creating section which, when the user authentication request is received, creates the identification web page that is exclusively for the received user authentication request; wherein
the identification mail transmitting section creates the identification mail including an address information of the identification web page created by the identification web page creating section.

16. The server as defined in claim 13, wherein
the authentication control section judges whether or not the user authentication request was originated by the user based on a return mail received from the user in reply to the identification mail.

17. The server as defined in claim 13, wherein
the user authentication request includes data of a public key certificate of the user; and
the identification mail transmitting section acquires the user's electronic mail address from the public key certificate.

18. A storage medium readable by a computer, the storage medium storing a program that causes the computer to function as a server with an authentication function which receives a user authentication request from a client machine via a network, also receives from the client machine in correlation with the user authentication request authentication data having a digital signature attached thereto using a private key of a user, and verifies the digital signature on the authentication data to thereby execute a user authentication process in response to the user authentication request, the program causing the computer to further function as:
an identification mail transmitting section which, when the user authentication request is received from the client machine, transmits to an electronic mail address of the user an identification mail that invites the user to make an input indicating whether or not the user authentication request was in fact originated by the user; and
an authentication control section which, when an input indicating that the user authentication request was originated by the user is not received from the user in reply to the transmitted identification mail, determines that the user authentication process is unsuccessful regardless of whether or not the digital signature on the authentication data is valid.

19. The storage medium as defined in claim 18, wherein
the identification mail transmitting section creates the identification mail including an address information of an identification web page for receiving the input indicating whether or not the user authentication request was originated by the user, and transmits the created identification mail to the electronic mail address of the user; and
the authentication control section judges whether or not the user authentication request was originated by the user based on the user's input with respect to the identification web page.

20. The storage medium as defined in claim 19, wherein the program causes the computer to further function as:
an identification web page creating section which, when the user authentication request is received, creates the identification web page that is exclusively for the received user authentication request; wherein
the identification mail transmitting section creates the identification mail including an address information of the identification web page created by the identification web page creating section.

21. The storage medium as defined in claim 18, wherein
the authentication control section judges whether or not the user authentication request was originated by the user based on a return mail received from the user in reply to the identification mail.

22. The storage medium as defined in claim 18, wherein
the user authentication request includes data of a public key certificate of the user; and
the identification mail transmitting section acquires the user's electronic mail address from the public key certificate.
